(19) United States
(12) Patent Application Publication
(10) Pub. No.: US 2021/0157382 A1
(43) Pub. Date: May 27, 2021

(54) METHOD AND SYSTEM FOR WAKING UP A CPU FROM A POWER-SAVING MODE

(71) Applicant: QUALCOMM INCORPORATED, SAN DIEGO, CA (US)

(72) Inventors: Bharat Kumar Rangarajan, Bangalore (IN); Rajesh Arimilli, Bangalore (IN)

(21) Appl. No.: 16/697,293

(22) Filed: Nov. 27, 2019

(51) Int. Cl. G06F 1/3206

(52) U.S. Cl. CPC G06F 1/3206; G05F 1/46

(57) ABSTRACT

A CPU core may be woken up from a power-saving mode in a portable computing device in a manner that depends upon whether the wake-up event source is a snoop request or an interrupt. A core power controller may monitor for and detect snoop requests and interrupts directed to the CPU core while the CPU core is in the power-saving mode. In response to detecting a snoop request, the core power controller may wake up snoop-related components of the CPU core while refraining from waking up non-snoop-related components of the CPU core. In response to detecting an interrupt, the core power controller may wake up both the snoop-related components and the non-snoop-related components of the CPU core.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices. PCDs commonly contain integrated circuits or systems-on-a-chip (“SoCs”) that include numerous components designed to work together to deliver functionality to a user. For example, an SoC may contain any number of processing engines such as modems, central processing units (“CPUs”) with multiple cores, graphical processing units (“GPUs”), etc.

As a PCD is powered by a battery, power conservation is an important feature. A PCD may have various components, including some within an SoC, that can be placed into various low-power states or modes that trade off power saving with performance. In a low-power mode a component is supplied with a reduced voltage, relative to a fully operational or fully active mode in which the component is supplied with a higher voltage. In accordance with a concept known as dynamic clock and voltage scaling (“DCVS”), in some low-power modes a clock frequency may be scaled along with the voltage. A component may be transitioned from one low-power mode to another, including one or more low-power modes in which the component is fully idle or inactive. The transition of a component from a low-power idle mode in which it is supplied with voltage below the level needed for operation and/or its clock signal is gated off may be referred to as a “wake-up” from the low-power idle mode. There is generally a tradeoff between the depth or extent to which the component's power level and/or activity level are diminished, and the wake-up latency or time required for the component to wake up. A CPU, for example, may be placed into any of a range of low-power modes, such as, for example, a mode in which both the power savings and wake-up latency are lowest, a mode in which both the power savings and wake-up latency are moderate, and a mode in which both the power savings and wake-up latency are highest.

A component such as a CPU may be woken up in response to various triggering events. It would be desirable to distinguish among such triggering events and perform the wake-up in a manner that depends upon the nature of the triggering event.

### SUMMARY OF THE DISCLOSURE

Systems, methods and computer program products are disclosed for waking up a CPU core from a low-power or power-saving mode in a PCD.

An exemplary method for waking up a CPU core from a power-saving mode in a PCD may include a core power controller monitoring to detect snoop requests and interrupts directed to the CPU core while the CPU core is in the power-saving mode. The method may further include waking up snoop-related components of the CPU core while refraining from waking up non-snoop-related components of the CPU core in response to detecting a snoop request directed to the CPU core. The method may still further include waking up both snoop-related components of the CPU core and non-snoop-related components of the CPU core in response to detecting an interrupt directed to the CPU core.

An exemplary system for waking up a CPU core from a power-saving mode in a PCD may include a core power controller. The core power controller may be configured to detect snoop requests and interrupts directed to the CPU core while the CPU core is in the power-saving mode. The core power controller may be further configured to wake up snoop-related components of the CPU core while refraining from waking up non-snoop-related components of the CPU core in response to detecting a snoop request directed to the CPU core. The core power controller may he still further configured to wake up both snoop-related components of the CPU core and non-snoop-related components of the CPU core in response to detecting an interrupt directed to the CPU core.

Another exemplary system for waking up a CPU core from a power-saving mode in a PCD may include: means for detecting snoop requests directed to the CPU core while the CPU core is in the power-saving mode; means for detecting interrupts directed to the CPU core while the CPU core is in the power-saving mode; means for waking up snoop-related components of the CPU core while refraining from waking up non-snoop-related components of the CPU core in response to detecting a snoop request directed to the CPU core; and means for waking up both snoop-related components of the CPU core and non-snoop-related components of the CPU core in response to detecting an interrupt directed to the CPU core.

An exemplary computer program product for waking up a CPU core from a power-saving mode in a PCD may comprise a computer-readable medium having instructions stored thereon. The instructions, when executed on a processor, may control a method that may include monitoring to detect snoop requests and interrupts directed to the CPU core while the CPU core is in the power-saving mode. The method may further include waking up snoop-related components of the CPU core while refraining from waking up non-snoop-related components of the CPU core in response to detecting a snoop request directed to the CPU core. The method may still further include waking up both snoop-related components of the CPU core and non-snoop-related components of the CPU core in response to detecting an interrupt directed to the CPU core.

### BRIEF DESCRIPTION OF TI-IF DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a PCD, in accordance with exemplary embodiments.

FIG. 2 is a flow diagram illustrating a method for waking up a CPU core from a power-saving mode in a PCD, in accordance with exemplary embodiments.

FIG. 3 is a block diagram of a system for waking up a CPU core from a power-saving mode in a PCD, in accordance with exemplary embodiments.

FIG. 4 is a flow diagram illustrating another method for waking up a CPU core from a power-saving mode in a PCD, in accordance with exemplary embodiments.

FIG. 5 is a block diagram of another system for waking up a CPU core from a power-saving mode in a PCI), in accordance with exemplary embodiments.

FIG. 6 is a block diagram of still another system for waking up a CPU core from a power-saving mode in a PCI), in accordance with exemplary embodiments.

FIG. 7 is a block diagram of a CPU core power controller configured by a computer program product for waking up a CPU core from a power-saving mode in a PCD, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “illustrative” or “exemplary” is not necessarily to be construed as preferred or advantageous over other aspects.

The terms “central processing unit” (“CPU”), “digital signal processor” (“DSP”), and “graphics processing unit” (“GPU”) are non-limiting examples of processors that may reside in a PCD. These terms are used interchangeably herein except where otherwise indicated. A component, system, subsystem, module, etc., of the PCD may include and operate under the control of such a processor.

Low-power or power-saving modes into which a CPU core or other processor or portion thereof may be placed may include one or more “idle” or “standby” modes in which the CPU core, processor, or portion thereof is not active. In the exemplary embodiments described below, a processor, such as a CPU core, may be placed into any selected one of at least three idle modes in a range of idle modes, which may be referred to as C1, C2 and C3. Nevertheless, in other embodiments such multiple modes may be referred to by other names, and there may be more or fewer modes. In the C1 (or other lowest power-savings mode), the processor may have one or more of its clock signals disabled but continue to be provided with a voltage level that would otherwise be sufficient to enable ordinary operation. Accordingly, wake-up latency from the C1 mode is lowest among these three modes. In the C3 (or other highest power-savings) mode, the voltage level provided to the processor may be collapsed, e.g., 0 volts. Accordingly, wake-up latency from the C3 mode is highest among these three modes. The C2 mode is an intermediate mode between C1 and C2. In the C2 mode the power savings may be less than in the C3 mode but greater than in the C1 mode, and the wake-up latency may be greater than in the C1 mode but less than in the C3 mode, The C2 or other intermediate mode may also be referred to as “retention mode” because the associated voltage level is sufficient to enable memories and other logic associated with the processor to retain (but not write or read) data. That is, the memory storage array elements may continue to be powered, but memory circuitry that is peripheral to the memory array elements may be power-collapsed, e.g., 0 volts. Similarly, state logic such as registers, flip-flops, etc., may retain their logic states in such a retention mode.

A CPU or CPU core can be woken up from the C2 mode by either an interrupt or a snoop request. As well understood by one of ordinary skill in the art, “snooping” is a scheme by which a cache memory coherency controller or similar component monitors bus transactions with the goal of maintaining cache coherency. A snoop request may be issued by a CPU core (or cluster of cores) to another CPU core (or cluster) with which it shares a cache. When a CPU core is woken up from the C2 mode in response to a snoop request, the CPU core typically automatically re-enters the C2 mode immediately after servicing the snoop request. In contrast, when a CPU core is woken up in response to an interrupt, the CPU core typically remains active until such time as it may again be placed into an idle mode. Regardless of whether it is an interrupt or a snoop request that is the source of the wake-up event, waking up the CPU core from the C2 mode conventionally comprises re-connecting all components in the CPU core to the same, single supply rail (i.e., single voltage) to which they were connected before the CPU core entered the idle mode. This conventional manner of waking up a CPU core may not be optimal under all circumstances.

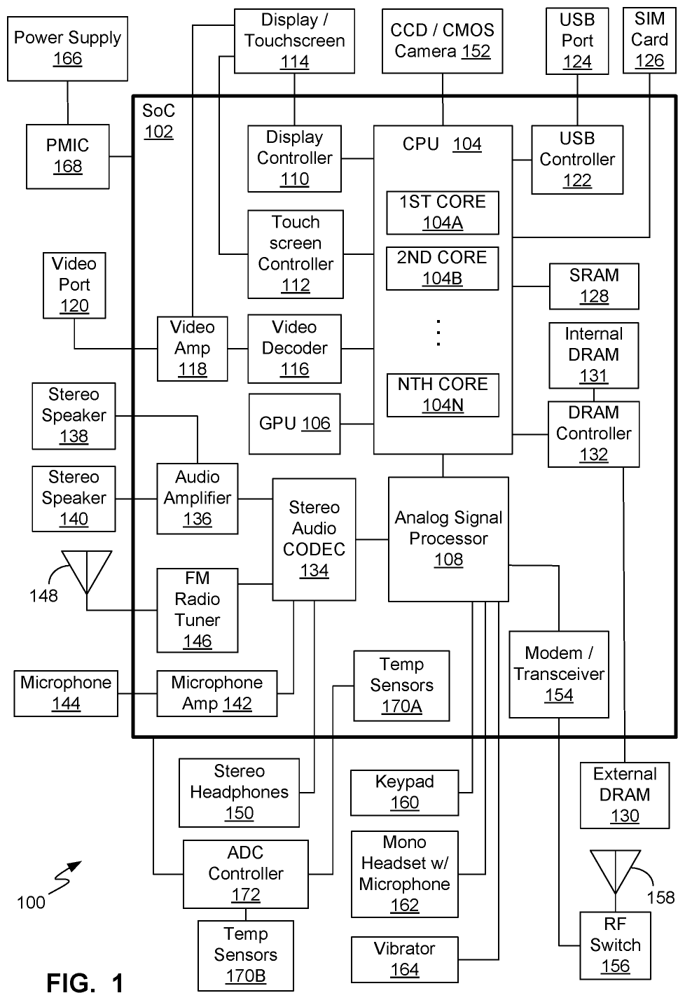

As illustrated in FIG. 1, illustrative or exemplary embodiments of systems and methods for optimizing CPU retention mode (e.g., C2) power depending upon whether a wake-up event source is a snoop request or an interrupt may be embodied in a PCD 100. The PCD 100 includes a system-on-a-chip (“SoC”) 102, i.e., a system embodied in an integrated circuit chip. The SoC 102 may include a CPU 104, a GPU 106, or other processors. The CPU 104 may include multiple cores, such as a first core 104A, a second core 104B, etc., through an Nth core 104N. The SoC 102 may include an analog signal processor 108.

A display controller 110 and a touchscreen controller 112 may be coupled to the CPU 104. A touchscreen display 114 external to the SoC 102 may be coupled to the display controller 110 and the touchscreen controller 112. The PCD 100 may further include a video decoder 116. The video decoder 116 is coupled to the CPU 104. A video amplifier 118 may be coupled to the video decoder 116 and the touchscreen display 114. A video port 120 may be coupled to the video amplifier 118. A universal serial bus (“USB”) controller 122 may also be coupled to CPU 104, and a USB port 124 may be coupled to the USB controller 122. A subscriber identity module (“SIM”) card 126 may also be coupled to the CPU 104.

One or more memories may be coupled to the CPU 104. The one or more memories may include both volatile and non-volatile memories. Examples of volatile memories include static random access memory (“SRAM”) 128 and dynamic RAMs (“DRAM”s) 130 and 131. Such memories may be external to the SoC 102, such as the DRAM 130, or internal to the SoC 102, such as the DRAM 131. A DRAM controller 132 coupled to the CPU 104 may control the writing of data to, and reading of data from, the DRAMs 130 and 131. In other embodiments, such a DRAM controller may be included within a processor, such as the CPU 104.

A stereo audio CODEC 134 may be coupled to the analog signal processor 108. Further, an audio amplifier 136 may be coupled to the stereo audio CODEC 134. First and second stereo speakers 138 and 140, respectively, may be coupled to the audio amplifier 136. In addition, a microphone amplifier 142 may be coupled to the stereo audio CODEC 134, and a microphone 144 may be coupled to the microphone amplifier 142. A frequency modulation (“FM”) radio tuner 146 may be coupled to the stereo audio CODEC 134, An FM antenna 148 may be coupled to the FM radio tuner 146, Further, stereo headphones 150 may be coupled to the stereo audio CODEC 134. Other devices that may be coupled to the CPU 104 include a digital (e.g., CCD or CMOS) camera 152.

A modem or radio frequency (“RF”) transceiver 154 may be coupled to the analog signal processor 108, An RF switch 156 may be coupled to the RF transceiver 154 and an RF antenna 158. In addition, a keypad 160, a mono headset with a microphone 162, and a vibrator device 164 may be coupled to the analog signal processor 108.

A power supply 166 may be coupled to the SoC 102 via a power management integrated circuit (“PMIC”) 168. The power supply 166 may include a rechargeable battery or a DC power supply that is derived from an AC-to-DC transformer connected to an AC power source.

The SoC 102 may have one or more internal or on-chip thermal sensors 170A and may be coupled to one or more external or off-chip thermal sensors 170B. An analog-to-digital converter (“ADC”) controller 172 may convert voltage drops produced by the thermal sensors 170A and 170B to digital signals.

The touch screen display 114, the video port 120, the USB port 124, the camera 152, the first stereo speaker 138, the second stereo speaker 140, the microphone 144, the FM antenna 148, the stereo headphones 150, the RE switch 156, the RF antenna 158, the keypad 160, the mono headset 162, the vibrator 164, the thermal sensors 170B, the ADC controller 172, the PMIC 168, the power supply 166, the DRAM 130, and the SIM card 126 are external to the SoC 102 in this exemplary or illustrative embodiment. It will be understood, however, that in other embodiments one or more of these devices may be included in such an SoC.

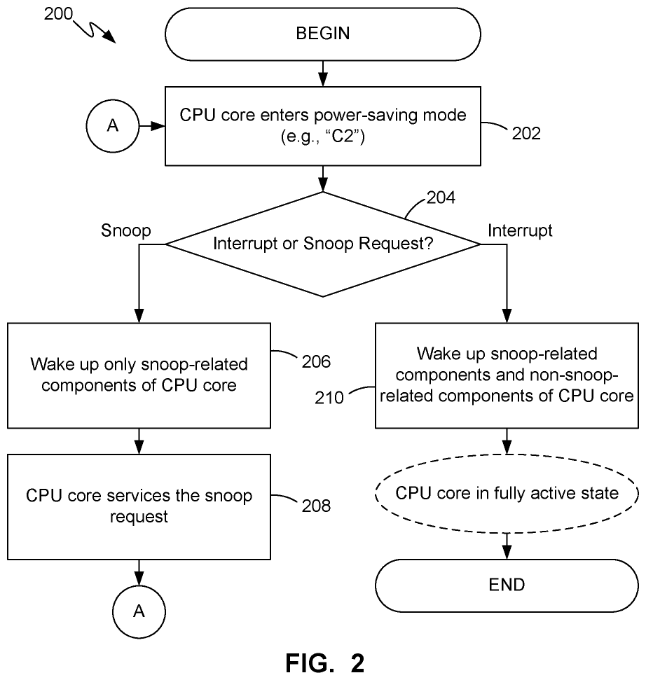

As illustrated in FIG, 2, a method 200 for waking up a CPU based on whether the source of the wake-up event is an interrupt or a snoop request may be performed or controlled in the above-described PCD 100 (FIG. 1) or other device. The method 200 relates to an idle mode, which may be the above-described C2 mode or other intermediate-level power-saving idle mode. It should be noted that in the C2 mode, the CPU core is incapable of accessing memory, such as cache memory (not shown in FIG. 2) associated with the CPU core, although the memory contents are retained. Similarly, in the C2 mode the contents or states of state logic such as registers, flip-flops, etc., are retained.

As indicated by block 202, a CPU core enters the idle mode. The CPU core may enter the idle mode in a conventional manner, in response to conventional triggering conditions. As one of ordinary skill in the art understands such aspects of PCD operation, they are not described in further detail herein. It is also understood that while in that idle mode an interrupt may be directed to the CPU core, and likewise, while in that idle mode, a snoop request may be directed to the CPU core. One of ordinary skill in the art further understands that the CPU core may respond to an interrupt or a snoop request by waking up. Aspects of the manner in which a CPU may wake up that are not described below may be conventional. It should be noted that the CPU core being in the idle mode means that all snoop-related components and all non-snoop-related components of the CPU core are in the idle mode.

The term “snoop-related component” means a component that is directly involved in servicing a snoop request and that is capable of being placed into an idle mode, Examples of snoop-related components are described below. Conversely, the term “non-snoop-related component” means a component that is not directly involved in servicing a snoop request and that is capable of being placed into an idle mode. The CPU core includes one or more snoop-related components and one or more non-snoop-related components. As defined herein, these sets of snoop-related components and non-snoop-related components are mutually exclusive; a component is either snoop-related or non-snoop-related but not both.

As indicated by block 204, while the CPU core is in the above-referenced (e.g., C2) idle mode, the CPU core may receive a snoop request or an interrupt. If the CPU core receives a snoop request while the CPU core is in the above-referenced idle mode, then snoop-related components of the CPU core are woken up (and non-snoop-related components of the CPU core are not woken up), as indicated by block 206. That is, while control logic (not shown in FIG. 2) actively engages in waking up the snoop-related components of the CPU core, the control logic actively refrains from engaging in waking up the non-snoop-related components of the CPU core. In accordance with block 206, all snoop-related components, i.e., all components that the CPU core needs to service that snoop request, are woken up.

As indicated by block 208, after the snoop-related components are woken up, the CPU core may service the snoop request in a conventional manner. As the manner in which a CPU core may service a snoop request is well understood by one of ordinary skill in the art, this aspect is not described herein. After the CPU core has serviced the snoop request, the method 200 may return to above-described block 202. That is, the CPU core may be placed into the same (e.g., C2) idle mode from which it was woken up.

If the CPU core receives an interrupt while the CPU core is in the above-referenced idle mode, then both the snoop-related and non-snoop-related components of the CPU core are woken up, as indicated by block 210. In the illustrated embodiment, once the snoop-related and non-snoop-related components of the CPU core have been woken up, the CPU core is in a fully active mode or state in which it is capable of performing its routine or mission-mode functions, including the ability to access memory associated with the CPU core. In some embodiments, the CPU core may be woken up into a higher-performance but not necessarily highest-performance mode.

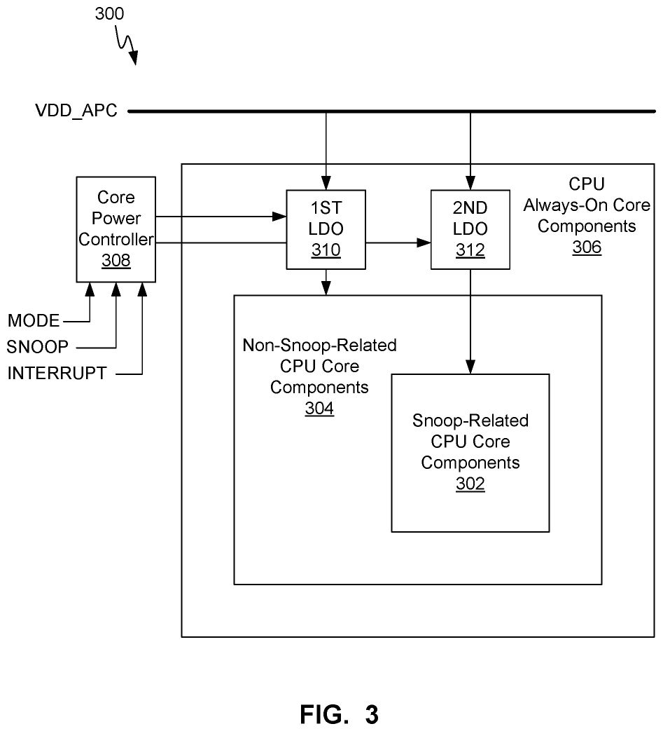

As illustrated in FIG. 3, a system 300 for waking up a CPU core based on whether the source of the wake-up event is an interrupt or a snoop request may include snoop-related CPU core components 302, non-snoop-related CPU core components 304, always-on CPU core components 306, and a CPU core power controller 308. The always-on CPU core components 306 are incapable of being placed into any idle mode. Regardless of in which idle mode the snoop-related and non-snoop-related CPU core components 302 and 304 may be, the always-on CPU core components 306 remain fully powered. The always-on CPU core components 306 may include a first voltage regulator 310 and a second voltage regulator 312, which may be, for example, low-dropout (“MO”) regulators. The first and second voltage regulators 310 and 312 are supplied by a processor power supply rail (“VDD APC”) and may be controlled by the CPU core power controller 308. The CPU core to which the system 300 relates may be, for example, one of the cores 104A-104N (FIG. 1).

The snoop-related CPU core components 302 define a snoop-related (first) power domain, and the non-snoop-related CPU core components 304 define a non-snoop-related (second) power domain. That is, all snoop-related CPU core components 302 are powered by the output of the second voltage regulator 312, and all non-snoop-related CPU core components 304 are powered by the output of the first voltage regulator 310. The CPU core power controller 308 may control the first voltage regulator 310 to selectively either output a regulated voltage that is lower than the voltage VDD APC or output the voltage VDD APC (effectively bypassing the voltage regulation function). Likewise, the CPU core power controller 308 may control the second voltage regulator 312. to selectively either output a regulated voltage that is lower than the voltage VDD_APC or output the voltage VDD_APC (effectively bypassing the voltage regulation function). Other embodiments (not shown) may omit the second voltage regulator 312.

The CPU core power controller 308 may control the first and second voltage regulators 310 and 312 in response to a MODE signal, a SNOOP signal, and an INTERRUPT signal, Although for purposes of clarity each of these three signals is depicted in FIG. 3 as associated with a single signal line that forms an input to the CPU core power controller 308, the MODE, SNOOP, and INTERRUPT signals may be defined by a combination of signals on multiple lines. The MODE signal indicates in which of the idle modes C1, C2 and C3 the CPU core is operating, The SNOOP signal, when asserted, indicates a snoop request directed to the CPU core. The INTERRUPT signal, when asserted, indicates an interrupt directed to the CPU core,

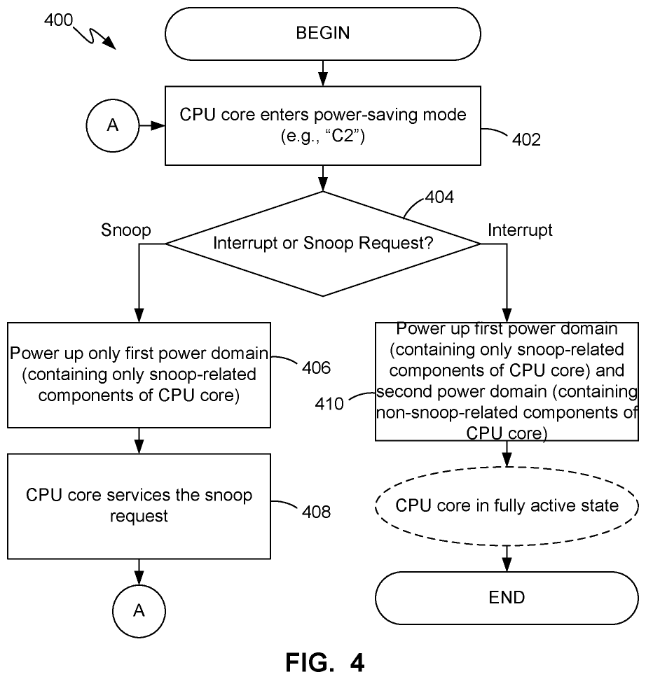

As illustrated in FIG. 4, a method 400 may be performed or controlled in the above-described system 300 (FIG. 3) or other system. The method 400 thus may be an example of the method 200 described above with regard to FIG. 2. As indicated by block 402, a CPU core enters the C2 idle mode. In response to the MODE signal having a state indicating the C2 idle mode, the CPU core power controller 308 (FIG. 3) enables both the first and second voltage regulators 310 and 312. The enabled first voltage regulator 310 supplies a voltage that is lower than the supply rail VDD APC to the non-snoop-related CPU core components 304 connected via the snoop-related power domain. The enabled second voltage regulator 312 supplies a voltage that is lower than the supply rail VDD APC to the snoop-related CPU core components 302 connected via the non-snoop-related power domain. The voltage supplied to the snoop-related and non-snoop-related power domains may be, for example, 0.4 V. This voltage may be referred to as a retention voltage, as it is sufficient to enable a memory device or state logic (not shown in FIG. 4) associated with the CPU core to retain data. However, the retention voltage is insufficient to enable data to be written to or read from the memory device or state logic and otherwise insufficient to enable any active or mission-mode operation.

As indicated by block 404, while the CPU core is in the C2 idle mode, the CPU core may receive a snoop request or an interrupt, respectively represented in FIG. 3 by the SNOOP and INTERRUPT signals. In response to assertion of the SNOOP signal while the MODE signal indicates the C2 idle mode, the CPU core power controller 308 maintains the first voltage regulator 310 in an enabled state but switches the second voltage regulator 312 to a bypassed state, in which the supply rail voltage VDD_APC is supplied directly to the snoop-related components 302 of the CPU core via the non-snoop-related power domain, as indicated by block 406. The supply rail voltage VDD APC is sufficient to enable the snoop-related CPU core components 302 to participate in servicing the snoop request. The CPU core may then utilize the snoop-related CPU core components 302 to service the snoop request, as indicated by block 408. After the CPU core has serviced the snoop request, the method 400 may return to above-described block 402. That is, the CPU core may re-enter the C2 idle mode.

In response to assertion of the INTERRUPT signal while the MODE signal indicates the C2 idle mode, the CPU core power controller 308 switches both the first and second voltage regulators 310 and 312 to a bypassed state, as indicated by block 410. In the bypassed state the first voltage regulator 310 directly couples the supply rail voltage VDD_APC to the non-snoop-related components 304 of the CPU core via the snoop-related power domain. Likewise, in the bypassed state the second voltage regulator 312 directly couples the supply rail voltage VDD_APC to the snoop-related components 304 of the CPU core via the non-snoop-related power domain.

It may be noted that another effect of a snoop request or interrupt is to change the MODE signal from indicating the C2 mode to indicating a fully operational mode. The PCD components involved in selecting or changing the MODE signal are not shown in FIGS. 3-4 for purposes of clarity.

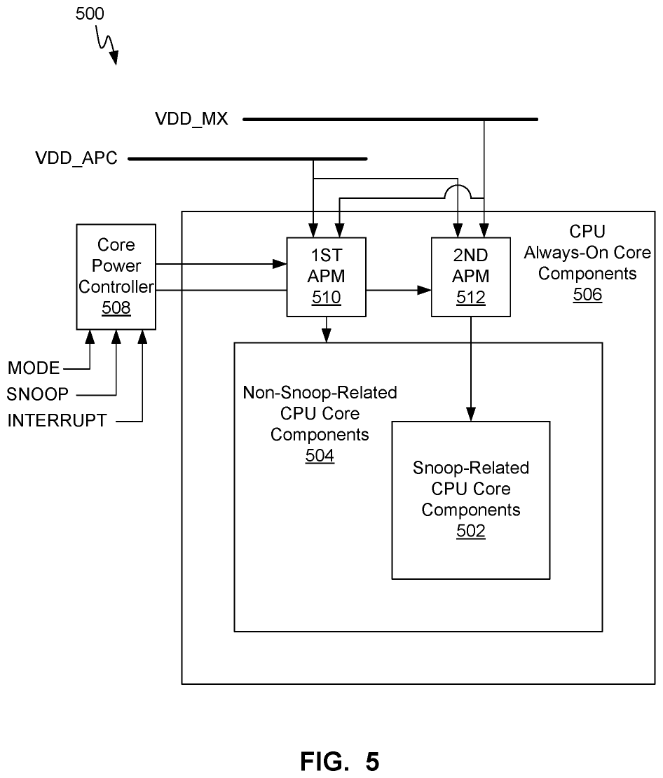

As illustrated in FIG. 5, in another embodiment a system 500 for waking up a CPU core based on whether the source of the wake-up event is an interrupt or a snoop request may include snoop-related CPU core components 502, non-snoop-related CPU core components 504, always-on CPU core components 506, and a CPU core power controller 508. The always-on CPU core components 506 may include a first array power multiplexer (“APM” or “power MUX”) 510 and a second power MUX 512. A first power input of the first power MUX 510 is coupled to the processor power supply rail (“VDD APC”), and a second power input of the first power MUX 510 is coupled to a memory power supply rail (“VDD_MX”). The output of the first power MUX 510 is coupled to the non-snoop-related CPU core components 504, which define a snoop-related (first) power domain. The first power MUX 510 is configured to couple either its first power input or its second power input to its output in response to selection signals received from the CPU core power controller 508. Similarly, a first power input of the second power MUX 512 is coupled to the VDD_APC supply rail, and a second power input of the second power MUX 512 is coupled to the VDD_MX supply rail, The output of the second power MUX 512 is coupled to the snoop-related CPU core components 502, which define a non-snoop-related (second) power domain, The second power MUX 512 is configured to couple either its first power input or its second power input to its output in response to selection signals received from the CPU core power controller 508. The CPU core power controller 508 may produce these selection signals in response to the MODE signal, the SNOOP signal, and the INTERRUPT signal to thereby control the first and second power MUXes 510 and 512.

In the system 500, selection of the voltage to be supplied to the snoop-related and non-snoop-related power domains may depend upon a DCVS mode. That is, DCVS techniques may be used, either independently of, or in combination with, the above-described idle modes to scale processor performance, Examples of DCVS modes include Nominal, Turbo, and Static Voltage Scaling (“SVS”). In each of these modes (Nominal, Turbo and SVS). both the CPU core supply voltage and the clock frequency are scaled. In the SVS mode, the supply voltage and clock frequency provide a lower-performance operating point than the supply voltage and clock frequency provide in Nominal mode. in the Turbo mode, the supply voltage and clock frequency provide a higher-performance operating point than the supply voltage and clock frequency provide in Nominal mode. The MODE signal in the system 500 may indicate both an idle mode and a DCVS mode.

In response to the MODE signal indicating that the CPU core is active, (i.e., not in any of the C1, C2 or C3 idle modes) and any of the Turbo, Nominal or SVS DCVS modes, the CPU core power controller 508 signals the first power MUX 510 to select its VDD_APC input to couple to its output and likewise signals the second power MUX 512 to select its VDD_APC input to couple to its output. Accordingly, both the non-snoop-related CPU core components 504 on the snoop-related power domain and the snoop-related CPU core components 502 on the non-snoop-related power domain are supplied with the voltage VDD_APC when the CPU core is active.

In response to the MODE signal indicating the C2 idle mode and the SVS DCVS mode, the CPU core power controller 508 signals the first power MUX 510 to select its VDD_APC input to couple to its output and likewise signals the second power MUX 512 to select its VDD_APC input to couple to its output, since the voltage level of VDD_APC is always lower than VDD_MX when the DCVS mode is SVS. Accordingly, both the non-snoop-related CPU core components 504 on the snoop-related power domain and the snoop-related CPU core components 502 on the non-snoop-related power domain are supplied with the voltage VDD_APC when the CPU core is in the C2 idle mode and the SVS DCVS mode. However, in response to the MODE signal indicating the C2 idle mode and the either the Nominal or Turbo DCVS mode, the CPU core power controller 508 signals the first power MUX 510 to select its VDD_MX input to couple to its output and likewise signals the second power ML1X 512. to select its VDD_MX input to couple to its output, since the voltage level of VDD_MX is always expected to he lesser than VDD_APC in nominal and Turbo DCVS modes. Accordingly, both the non-snoop-related CPU core components 504 on the snoop-related power domain and the snoop-related CPU core components 502 on the non-snoop-related power domain are supplied with the voltage VDD_MX when the CPU core is in the C2 idle mode and either the Nominal or Turbo DCVS mode.

In response to assertion of the SNOOP signal while the MODE signal indicates the C2 idle mode, the CPU core power controller 508 signals the second power MUX 512 to select its VDD_APC input to couple to its output, and thus signals the first power MUX 510 to continue in its then-existing input selection. Thus, if the DCVS mode is SVS at the time the SNOOP signal is asserted in the C2 idle mode, the non-snoop-related. CPU core components 504 on the non-snoop-related power domain continue to he supplied with the voltage VDD_APC and the snoop-related CPU core components 502 on the snoop-related power domain continue to he supplied with the voltage VDD_APC. However, if the DCVS mode is Nominal or Turbo at the time the SNOOP signal is asserted in the C2 idle mode, the non-snoop-related CPU core components 504 on the non-snoop-related power domain continue to be supplied with the voltage VDD_MX but the snoop-related CPU core components 502 on the snoop-related power domain are switched from being supplied with the voltage VDD_MX to being supplied with the voltage VDD_APC.

In response to assertion of the INTERRUPT signal while the MODE signal indicates the C2 idle mode, the CPU core power controller 508 signals both the first and second power MUXes 510 and 512 to select their VDD_APC inputs to couple to their outputs, regardless of DCVS mode. Thus, regardless of whether the DCVS mode is Nominal, Turbo, or SVS at the time the INTERRUPT signal is asserted in the C2 idle mode, the non-snoop-related CPU core components 504 on the non-snoop-related power domain and the snoop-related CPU core components 502 on the snoop-related power domain are supplied with the voltage VDD_APC.

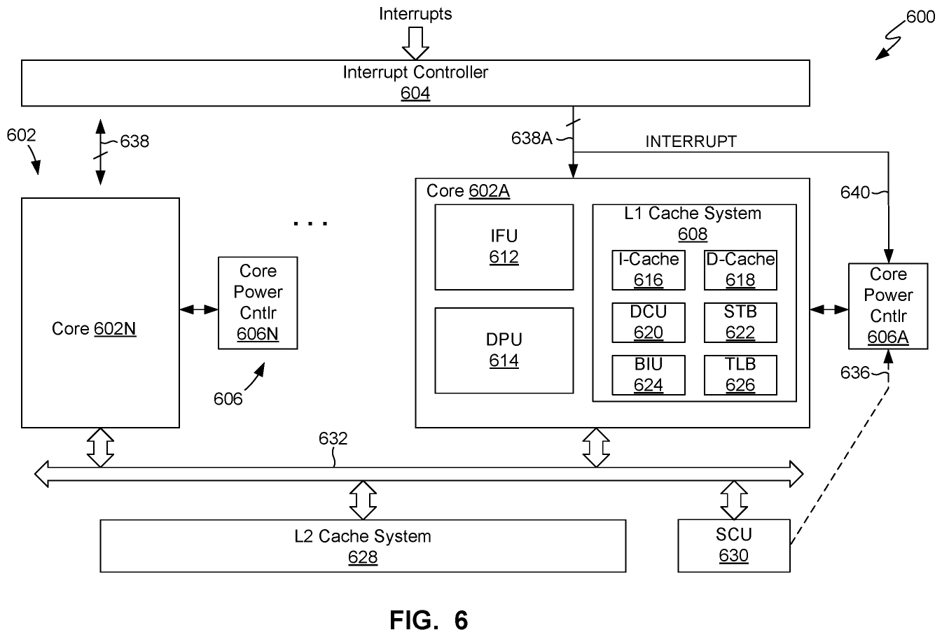

As illustrated in FIG. 6, a multi-core processing system 600 may include a plurality (N) of CPU cores 602, i.e., a first core 602A through an Nth core 602N, with the remaining cores 602 between the first core 602A and the Nth core 602N not shown in FIG. 6 for purposes of clarity but indicated by the ellipsis symbol (“ . . . ”). The CPU cores 602 may be examples of the cores 104A-104N in FIG. 1. The plurality of CPU cores 602 may also be referred to as a cluster of CPUs or cluster of cores. The system 600 may also include an interrupt controller 604 that interfaces with each of the CPU cores 602. The system 600 may further include a plurality (N) of CPU core power controllers 606, i.e., a first CPU core power controller 606A through an Nth CPU core power controller 606N, each configured to control the power supplied to a corresponding one of the CPU cores 602.

As illustrated in FIG. 6 by the first CPU core 602A, each CPU core 602 may include, among other elements that may not be shown for purposes clarity, an L1 cache (memory) system 608, an instruction Fetch Unit (“IFU”) 612, and a Data. Processing Unit (“DPU”) 614. The L1 cache system 608 may include an instruction cache 616, a data cache 618, a Data Cache Unit (“DCU”) 620, a Store Buffer 622, a Bus Interface Unit (“MU”) 624, and a Translation Lookaside Buffer (“TLB”) 626.

The system 600 may further include an L2 cache (memory) system 628. The system 600 may still further include a Snoop Control Unit (“SCID”) 630. The CPU cores 602, L2 cache system 628, and SCID 630 may be interconnected via one or more buses 632.

Although the functions of the foregoing elements of each CPU core 602 are well understood by one of ordinary skill in the art, the following general aspects may be noted. The IFU 612 fetches instructions from the L1 instruction cache 616. The DPU 614 decodes and executes instructions fetched by the IFU 612. The DCU 620 controls the data cache 618 and is involved in processing snoop requests. The BIU 624 arbitrates and schedules bus requests. The TLB 626 translates memory addresses relating to the caches 616 and 618.

The SCU 630 may handle or process snoop requests for maintaining coherency between the L1 cache system 608 and the L2 cache system 628. Generally, the SCU 630 may receive a snoop request from one of the CPU cores 602 that is directed to another of the CPU cores 602, A CPU core 602 may respond to or service a snoop request by providing information to the SCU 630.

Each of the CPU core power controllers 606 may be an example of the CPU core power controller 308 described above with regard to FIG. 3 or the CPU core power controller 508 described above with regard to FIG. 5. Detection of signals indicating snoop requests by the core power controller 606 is conceptually represented in FIG. 6 by the broken-line arrow 636. The SNOOP signals described above with regard to FIGS. 3 and 5 may similarly be conceptual representations of signals communicated from one of the CPU cores 602 or SCU 630 to a corresponding one of the CPU core power controllers 606. Signals indicating interrupts are included in the signals 638 communicated from the interrupt controller 604 to each CPU core 602, such as the INTERRUPT signal 640 included in signals 638A from the interrupt controller 604 to the first CPU core 602A. Although not shown for purposes of clarity, an interrupt router may route signals indicating interrupts from the interrupt controller 604 to one of the CPU cores 602 to which the interrupt is directed.

Examples of snoop-related components of a CPU core 602 include, but are not limited to, the IFU 612, the DCU 620, and the MU 624. Examples of non-snoop-related components of a CPU core 602 include, but are not limited to, the DPU 614, and the TLB 626, Any component of a CPU core 602 that is involved in receiving or processing an interrupt is a non-snoop-related component. Also, although not shown for purposes of clarity, any component of a CPU core 602 that is not directly involved in snoop requests or interrupts but that could be capable of being placed in an idle mode, such as, for example, a component that facilitates debugging, is a non-snoop-related component.

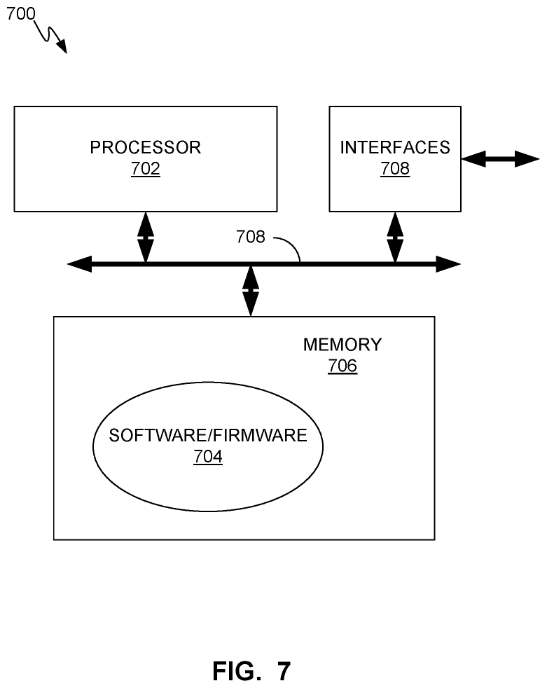

The CPU core power controller 606 may comprise a state machine (not shown) or other logic that monitors for, and detects, any snoop requests and interrupts that occur while the CPU core 602 is in an idle mode, and wakes up snoop-related and non-snoop-related CPU core components, in the manner described above with regard to FIGS. Alternatively, or in addition, as shown in FIG. 7, a power controller 700 (which may be an example of the CPU core power controller 606 of FIG. 6) or similar control element configured to perform such functions may comprise a processor 702 that is configured by software (or firmware) 704. That is, execution of the software 704 by the processor 702 may configure the processor 702 to control portions of the methods described above with regard to FIGS. 2-5. The processor 702, as configured by the software 704, also may define means for controlling the corresponding functions of the software 704. The software 704 may reside in a memory 706. Interfaces 708 may be included to couple the power controller 700 to external elements, such as, for example, the corresponding CPU core 602 (FIG. 6), the interrupt controller 604, power sources (e.g., PMIC 168 in FIG. 1), etc. The processor 702, memory 706, interfaces 708, and any other elements (not shown) may be coupled together via one of more buses 710 or other interconnections. It should be understood that the processor 702 may be any except that which is in the idle mode (e.g., CPU core 602) and thus subject to being woken up while the processor 702 is operating in accordance with the above-described methods.

Although for purposes of clarity the software 704 is depicted in FIG. 7 as stored or residing in the memory 706 as a discrete or unitary element, one of ordinary skill in the art understands that the software 704 may be retrieved from the memory 706 or other source(s), and executed by the processor 702 or other processor, in accordance with conventional computing principles, such as on an as-needed basis, in portions such as words, instructions, segments, objects, files, etc., and that the software 704 may be distributed among more than one such memory or other storage source. The memory 706 or other memory from which the software 704 is retrieved for execution may be volatile (e.g., DRAM) or non-volatile (e.g., flash). Such memories may include those described above with regard to FIG. 1. Similarly, the processing task or tasks represented by the execution of the software 704 may be distributed among multiple processors. The memory 706 or other such memory or storage medium having the software 704 or a portion thereof stored thereon in computer-readable form may be an example of a “computer program product,” “computer-readable medium,” etc., as such terms are understood in the patent lexicon.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for waking up a central processing unit (“CPU”) core from a power-saving mode in a portable computing device, comprising:
monitoring, by a core power controller, to detect snoop requests directed to the CPU core while snoop-related components and non-snoop-related components of the CPU core are in the power-saving mode;
monitoring, by the core power controller, to detect interrupts directed to the CPU core while the snoop-related components and the non-snoop-related components of the CPU core are in the power-saving mode;
waking up the snoop-related components of the CPU core while refraining from waking up the non-snoop-related components of the CPU core in response to detecting a snoop request directed to the CPU core; and
waking up snoop-related components of the CPU core and non-snoop-related components of the CPU core in response to the CPU core detecting an interrupt directed to the CPU core.

2. The method of claim 1, further comprising:
the CPU core servicing the snoop request; and
the CPU core re-entering the power-saving mode after servicing the snoop request.

3. The method of claim 1, wherein waking up the snoop-related components of the CPU core while refraining from waking up the non-snoop-related components of the CPU core comprises applying a higher power level to a first power domain containing the snoop-related components and applying a lower power level to a second power domain containing the non-snoop-related components.

4. The method of claim 3, wherein the lower power level exceeds a threshold enabling logic associated with the CPU core to retain data.

5. The method of claim 3, wherein the power-saving mode is a C2 mode, and the C2 mode provides a power savings level greater than a power savings level provided by a C1 mode and less than a power savings level provided by a C3 mode.

6. The method of claim 3, wherein the first power domain is supplied by a first low-dropout power regulator coupled to a power supply rail, and the second power domain is supplied by a second low-dropout power regulator coupled to the power supply rail.

7. The method of claim 3, wherein the first and second power domains are selectably supplied by a first power multiplexer coupled to a first power supply rail and a second power multiplexer coupled to a second power supply rail.

8. The method of claim 1, wherein the CPU core is one of a plurality of CPU cores of a multi-core CPU in a system-on-a-chip.

9. A system for waking up a central processing unit (“CPU”) core from a power-saving mode in a portable computing device, comprising:
a core power controller configured to monitor to detect snoop requests and interrupts directed to the CPU core while snoop-related components and non-snoop-related components of the CPU core are in the power-saving mode;
wherein the core power controller is further configured to wake up the snoop-related components of the CPU core while refraining from waking up the non-snoop-related components of the CPU core in response to detecting a snoop request directed to the CPU core; and
wherein the core power controller is further configured to wake up the snoop-related components of the CPU core and the non-snoop-related components of the CPU core in response to the CPU core detecting an interrupt directed to the CPU core.

10. The system of claim 9, further comprising:
snoop control logic configured to service the snoop request;
wherein the core power controller is configured to re-enter the CPU core into the power-saving mode after the snoop request has been serviced.

11. The system of claim 9, wherein the core power controller is configured to apply a higher power level to a first power domain containing the snoop-related components and apply a lower power level to a second power domain containing the non-snoop-related components to wake up the snoop-related components of the CPU core while refraining from waking up the non-snoop-related components of the CPU core comprises.

12. The system of claim 11, wherein the lower power level exceeds a threshold enabling logic associated with the CPU core to retain data.

13. The system of claim 11, wherein the power-saving mode is a C2 mode, and the C2 mode provides a power savings level greater than a power savings level provided by a C1 mode and less than a power savings level provided by a C3 mode.

14. The system of claim 11, wherein the first power domain is supplied by a first low-dropout power regulator coupled to a power supply rail, and the second power domain is supplied by a second low-dropout power regulator coupled to the power supply rail.

15. The system of claim 11, wherein the first and second power domains are selectably supplied by a first power multiplexer coupled to a first power supply rail and a second power multiplexer coupled to a second power supply rail.

16. The system of claim 9, wherein the CPU core is one of a plurality of CPU cores of a multi-core CPU in a system-on-a-chip.

17. A system for waking up a central processing unit (“CPU”) core from a power-saving mode in a portable computing device, comprising:
means for monitoring, by a core power controller, to detect snoop requests directed to the CPU core while snoop-related components and non-snoop-related components of the CPU core are in the power-saving mode;
means for monitoring, by a core power controller, to detect interrupts directed to the CPU core while the snoop-related components and the non-snoop-related components of the CPU core are in the power-saving mode;
means for waking up the snoop-related components of the CPU core while refraining from waking up the non-snoop-related components of the CPU core in response to detecting a snoop request directed to the CPU core; and
means for waking up the snoop-related components of the CPU core and the non-snoop-related components of the CPU core in response to the CPU core detecting an interrupt directed to the CPU core.

18. The system of claim 17, further comprising:
means for servicing the snoop request; and
means for re-entering the CPU core into the power-saving mode after servicing the snoop request.

19. The system of claim 17, wherein the means for waking up the snoop-related components of the CPU core while refraining from waking up the non-snoop-related components of the CPU core comprises means for applying a higher power level to a first power domain containing the snoop-related components and applying a lower power level to a second power domain containing the non-snoop-related components.

20. The system of claim 19, wherein the lower power level exceeds a threshold enabling logic associated with the CPU core to retain data.

21. The system of claim 19, wherein the power-saving mode is a C2 mode, and the C2 mode provides a power savings level greater than a power savings level provided by a C1 mode and less than a power savings level provided by a C3 mode.

22. The system of claim 19, wherein the first power domain is supplied by a first low-dropout power regulator coupled to a power supply rail, and the second power domain is supplied by a second low-dropout power regulator coupled to the power supply rail.

23. The system of claim 19, wherein the first and second power domains are selectably supplied by a first power multiplexer coupled to a first power supply rail and a second power multiplexer coupled to a second power supply rail.

24. The system of claim 17, wherein the CPU core is one of a plurality of CPU cores of a multi-core CPU in a system-on-a-chip.

25. A computer program product for waking up a central processing unit (“CPU”) core from a power-saving mode in a portable computing device, the computer program product comprising a computer-readable medium having stored thereon instructions that when executed on a processor control a method comprising:
monitoring to detect snoop requests directed to the CPU core while snoop-related components and non-snoop-related components of the CPU core are in the power-saving mode;
monitoring to detect interrupts directed to the CPU core while the snoop-related components and the non-snoop-related components of the CPU core are in the power-saving mode;
waking up the snoop-related components of the CPU core while refraining from waking up the non-snoop-related components of the CPU core in response to detecting a snoop request directed to the CPU core; and
waking up the snoop-related components of the CPU core and the non-snoop-related components of the CPU core in response to the CPU core detecting an interrupt directed to the CPU core.

26. The computer program product of claim 25, wherein the method further comprises:
the CPU core servicing the snoop request; and
the CPU core re-entering the power-saving mode after servicing the snoop request.

27. The computer program product of claim 25, wherein waking up the snoop-related components of the CPU core while refraining from waking up the non-snoop-related components of the CPU core comprises applying a higher power level to a first power domain containing the snoop-related components and applying a lower power level to a second power domain containing the non-snoop-related components.

28. The computer program product of claim 27, wherein the lower power level exceeds a threshold enabling logic associated with the CPU core to retain data.

29. The computer program product of claim 27, wherein the power-saving mode is a C2 mode, and the C2 mode provides a power savings level greater than a power savings level provided by a C1 mode and less than a power savings level provided by a C3 mode.

30. The computer program of claim 25, wherein the processor is one of a plurality of CPU cores of a multi-core CPU in a system-on-a-chip.
